(19) United States
(12) Patent Application Publication
(10) Pub. No.: US 2021/0216603 A1
(43) Pub. Date: Jul. 15, 2021

(54) RECIPE SUGGESTION APPARATUS, RECIPE SUGGESTION METHOD, AND NON-TRANSITORY COMPUTER READABLE MEDIUM FOR RECIPE SUGGESTION

(71) Applicant: Cookpad Inc., Tokyo (JP)

(72) Inventors: Shinya OHTANI, Tokyo (JP); Masayuki IOKI, Tokyo (JP); Akihisa KANEKO, Tokyo (JP); Tomomichi SUMI, Tokyo (JP)

(73) Assignee: Cookpad Inc., Tokyo (JP)

(21) Appl. No.: 17/213,253

(22) Filed: Mar. 26, 2021

Related U.S. Application Data
(63) Continuation of application No. PCT/JP2019/032295, filed on Aug. 19, 2019.

(30) Foreign Application Priority Data
Sep. 28, 2018 (JP) 2018-185928

(51) Int. Cl. G06F 16/9535; G06F 16/9538

(52) U.S. Cl. CPC G06F 16/9535; G06F 16/9538

(57) ABSTRACT

A recipe suggestion apparatus which includes a memory that stores a plurality of recipes, and circuitry that obtains, via the internet, spec information on a cooking appliance of a predetermined user from a user terminal of the predetermined user or the cooking appliance, the spec information indicating a performance upper limit of the cooking appliance, identifies, from the plurality of recipes, at least one target recipe in which a value of a cooking operation corresponding to a quantitative description falls within a predetermined range of the performance upper limit indicated by the spec information, and sends, via the internet, the identified target recipe to the user terminal.

### CROSS-REFERENCE TO RELATED APPLICATIONS

This application is a continuation of International Patent Application No. PCT/JP2019/032295, filed on Aug. 19, 2019, which claims priority from Japanese Patent Application No. 2018-185928, filed on Sep. 28, 2018, both of which are incorporated by reference herein in its entirety.

### TECHNICAL FIELD

The present disclosure relates to a recipe suggestion apparatus, a recipe suggestion method and a recipe suggestion program.

### BACKGROUND

It is hard for many people, including those other than housewives who cook every day, to decide what to make at an opportunity of cooking. As a solution to this problem, there is a service that receives recipes posted by various users, including professional and amateur cooks, and distributes or publishes the recipes on the Internet.

However, the service described above publishes a vast number of recipes, and it can take a lot of time and effort for a user to choose a preferable recipe.

As a technique relating to such choice of recipe, Patent Literature 1 discloses an information processing apparatus that chooses dish information that fits to a cooking environment, such as time period or weather, as recommended dish information from among a plurality of pieces of dish information based on cooking environment information that indicates the cooking environment, and recommends the dish information to a user.

According to Patent Literature 1, a recipe that meets a time period, weather or other condition can be suggested to a user.

### CITATION LIST

### Patent Literature

Patent Literature 1: Japanese Patent Laid-Open No. 2007-334605

### SUMMARY

The present disclosure provides recipe suggestion apparatus, comprising: a memory that stores a plurality of recipes; and circuitry configured to obtain, via the internet, spec information on a cooking appliance of a predetermined user from a user terminal of the predetermined user or the cooking appliance, the spec information indicating a performance upper limit of the cooking appliance, identify, from the plurality of recipes, at least one target recipe in which a value of a cooking operation corresponding to a quantitative description falls within a predetermined range of the performance upper limit indicated by the spec information, and send, via the internet, the identified target recipe to the user terminal.

### BRIEF DESCRIPTION OF DRAWINGS

FIG. 1 is a diagram showing an example of a network configuration including a recipe suggestion apparatus according to an embodiment.

FIG. 2 is a diagram showing a configuration example of the recipe suggestion apparatus according to this embodiment.

FIG. 3 is a diagram showing a configuration example of a user terminal according to this embodiment.

FIG. 4 is a diagram showing a configuration example of electrical kitchen appliance according to this embodiment.

FIG. 5 is a diagram showing a configuration example of spec information according to this embodiment.

FIG. 6 is a diagram showing a configuration example of a recipe table according to this embodiment.

FIG. 7 is a diagram showing a configuration example of a usage history table according to this embodiment.

FIG. 8 is a diagram showing a configuration example of a cooking property table according to this embodiment.

FIG. 9 is a diagram showing a flow example of a recipe suggestion method according to this embodiment.

FIG. 10 is a diagram showing a screen example 1 according to this embodiment.

FIG. 11 is a diagram showing a screen example 2 according to this embodiment.

FIG. 12 is a diagram showing a screen example 3 according to this embodiment.

FIG. 13 is a diagram showing a screen example 4 according to this embodiment.

### DETAILED DESCRIPTION

### Technical Problem

The conventional technique described above enables recipe suggestion according to the environment of a user. However, in preparation for the so-called smart kitchen technology, there are other factors that need to be taken into account.

In the smart kitchen technology, recipes are programmed in electrical kitchen appliances so that various cooking operations can be automatically done. However, different electrical kitchen appliances of different users, in which recipes are to be programmed, have different specs.

Therefore, if a recipe is suggested simply based on the external environment or the like, some user may be unable to get the most out of the performance of their electrical kitchen appliance, and fail to prepare a dish with an appropriate efficiency or quality.

In addition, users who want to use recipes for cooking tend to prefer to save time and effort in cooking. On the other hand, such users also tend to wish to make a fancy dish by using a recipe filled with know-how of professional cooks or the like.

However, no technique has been proposed that is based on such a recipe usage as described above and suggests a preferable recipe by taking the personal taste of a user into account.

An object of the present disclosure is to provide a technique that enables suggestion of an appropriate recipe that meets the specs of an electrical kitchen appliance or the personal taste of a user.

### Solution to Problem

To attain the object described above, a recipe suggestion apparatus according to an aspect of the present disclosure is a recipe suggestion apparatus including: a recipe storage part that stores recipes, and a recipe suggestion part that obtains spec information on a cooking appliance of a predetermined user from a terminal of the user or the cooking appliance, identifies, in the recipes, a recipe a value of a cooking operation corresponding to a quantitative description in which falls within a predetermined range from a performance upper limit in the spec information, and delivers the identified recipe to the terminal of the user.

The recipe suggestion apparatus according to the aspect of the present disclosure may further include a usage history storage part that stores a usage history of a recipe for the user, and the recipe suggestion part may determine a property personally required by the user for cooking according to a recipe based on at least any of an actual cooking time of the user, a cooking detail, and a predetermined attribute of a recipe used by the user indicated by the usage history, identify a recipe that includes the property as an attribute, and deliver the identified recipe to the terminal of the user.

To attain the object described above, a recipe suggestion method according to an aspect of the present disclosure is a recipe suggestion method, wherein an information processing apparatus that stores recipes performs a step of obtaining spec information on a cooking appliance of a predetermined user from a terminal of the user or the cooking appliance, a step of identifying, in the recipes, a recipe a value of a cooking operation corresponding to a quantitative description in which falls within a predetermined range from a performance upper limit in the spec information, and a step of delivering the identified recipe to the terminal of the user.

In the recipe suggestion method according to the aspect of the present disclosure, the information processing apparatus may further store a usage history of a recipe for the user, and may determine a property personally required by the user for cooking according to a recipe based on at least any of an actual cooking time of the user, a cooking detail, and a predetermined attribute of a recipe used by the user indicated by the usage history, identify a recipe that includes the property as an attribute, and deliver the identified recipe to the terminal of the user.

To attain the object described above, a recipe suggestion program according to an aspect of the present disclosure is a recipe suggestion program that makes an information processing apparatus that stores recipes perform a step of obtaining spec information on a cooking appliance of a predetermined user from a terminal of the user or the cooking appliance, a step of identifying, in the recipes, a recipe a value of a cooking operation corresponding to a quantitative description in which falls within a predetermined range from a performance upper limit in the spec information, and a step of delivering the identified recipe to the terminal of the user.

In the recipe suggestion program according to the aspect of the present disclosure, the recipe suggestion program may make the information processing apparatus that further stores a usage history of a recipe for the user perform a step of determining a property personally required by the user for cooking according to a recipe based on at least any of an actual cooking time of the user, a cooking detail, and a predetermined attribute of a recipe used by the user indicated by the usage history, a step of identifying a recipe that includes the property as an attribute, and a step of delivering the identified recipe to the terminal of the user.

### Advantageous Effect of Disclosure

According to the present disclosure, an appropriate recipe can be suggested which meets the specs of an electrical kitchen appliance or the personal taste of a user.

<Network Configuration Including Recipe Suggestion Apparatus>

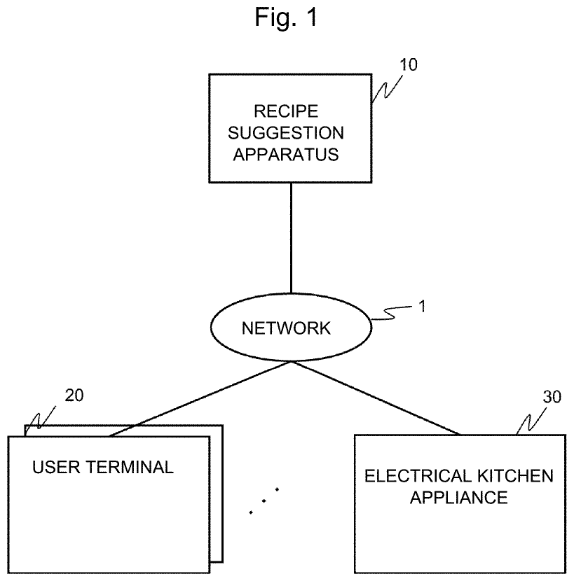

In the following, an embodiment will be described in detail with reference to the drawings. FIG. 1 is a diagram showing an example of a network configuration including a recipe suggestion apparatus 10 according to this embodiment.

The recipe suggestion apparatus 10 according to this embodiment may be an apparatus that manages and operates a so-called recipe website. The recipe suggestion apparatus 10 illustrated herein is a web server that publishes the recipe website described above on a network 1 such as the Internet.

On the recipe website published by the recipe suggestion apparatus 10, various users, including professionals, amateurs, names and no-names, post their recipes. On the other hand, various users access the website and browse recipes in a relevant genre or posted by a favorite recipe poster.

The recipe can be posted or browsed in any data format. However, the machine readable recipe (MRR) format can be typically used, for example.

A recipe in the MRR format is a recipe that can be read by a cooking appliance (an electrical kitchen appliance 30 described later), such as a microwave oven. On the other hand, a recipe including a mixture of qualitative expressions and quantitative expressions that can be read by humans is referred to as a recipe in the human readable recipe (HRR) format.

With a conventional recipe in the HRR format described above or other format, one cooking operation is often described by various different expressions depending on the recipe poster, and the cooking precision tends to be low even if such expressions are set in the cooking appliance. The recipe in the MRR format is rid of descriptions irrelevant to the cooking operation, expression inconsistencies, grammatical errors and the like, which can be included in the conventional recipe.

The data of the recipe in the MRR format is expressed by a graph (directed graph) formed by a plurality of nodes and edges between the nodes, for example. In this graph, nodes define a state transition of an ingredient, and an edge indicates an action required for the state transition between nodes.

Table 1 shows types of the nodes described above.

TABLE 1

| type of node | description |
|---|---|
| ingredient | This node indicates an ingredient of a dish. The graph |
| node | starts with this node. An ingredient ID is needed. |
| intermediate | This node has an IN edge and an OUT edge, and |
| node | indicates an intermediate state of a dish. |
| waste node | This node indicates a peeled skin or the like. This node |
| | is one of end nodes but does not indicate cooking. |
| dish node | This node is an end node that indicates a dish. |
| special node | This node is a preliminary node for an appliance. For |
| | example, this node indicates preheating an oven. |

Each node can be assigned with an attribute, such as those shown in Table 2, as a node attribute. In this example, it is assumed that the node is an ingredient node that indicates “carrot”.

TABLE 2

| attribute of node | legend |
|---|---|
| state | raw |
| name | carrot (or ingredient ID) |
| amount | amount (weight) of ingredient |

Each edge may be assigned with an attribute, such as those shown in Table 3, as an edge attribute.

TABLE 3

| attribute of edge | description |
|---|---|
| name | action name, such as “cut” or “heat” |
| action ID | ID corresponding to action name |
| end condition | condition for ending action, such as |
| | dice “into 3 cm cubes” or simmer |
| | “for five minutes” |
| appliance | ID of appliance, such as “oven” or |
| | “microwave oven” |
| order of edges | number indicating order of actions |

The term “action” described above means a basic operation of a cooking procedure. For example, an action is an operation such as “cutting” or “heating”. An action may also include a specific set temperature of an appliance, a cooking time, and a detail of an operation, for example.

A specific example of nodes will be described below. When preparing a salad, the dish node is “salad”. The ingredient nodes are “onion”, “cucumber”, “tomato”, “ketchup” and “mayonnaise”, for example. Each ingredient node is assigned with an ID that uniquely identifies the ingredient.

The ingredient node “onion” is connected to an intermediate node “chopped onion” by an edge (action) “cut”. The ingredient node “cucumber” is connected to an intermediate node “1-cm cucumber cubes” by an edge (action) “cut”.

The ingredient node “tomato” is connected to an intermediate node “half tomato” by an edge (action) “cut”. The ingredient node “ketchup” and the ingredient node “mayonnaise” are connected to an intermediate node “aurora sauce” by an edge (action) “mix”. Note that each of the edges “cut” and “mix” is assigned with an ID that uniquely identifies the action.

The intermediate nodes “chopped onion”, “1-cm cucumber cubes” and “half tomato” are connected to the dish node “salad” by an edge (action) “plate”. The intermediate node “aurora sauce” is connected to the dish node “salad” by an edge (action) “dress”. Note that each of the edges “plate” and “dress” is assigned with an ID that uniquely identifies the action.

The order of the edges is set so that “dress” occurs after “plate”. The action “dress” may be replaced with an action “toss”.

When state transitions of ingredients are expressed by a graph as described above, each ingredient is assigned with an ingredient ID that uniquely identifies the ingredient, and each action required for a state transition is assigned with an action ID that uniquely identifies the action.

Therefore, a machine can easily and reliably read recipe information based on the IDs. In addition, the appliance to perform the action does not need to be specified in the recipe information, so that the recipe can be used with various appliances including future appliances. Furthermore, since all the actions are expressed as an edge, each action can be easily extracted from the recipe information.

A user of the recipe website can be a poster or browser of the user's own will. In the following description, however, the recipe poster and the browser will be collectively referred to as a user. Thus, in addition to the recipe suggestion apparatus 10, a user terminal 20 of a poster or a browser is also communicably connected to the network 1 illustrated in FIG. 1.

The user terminal 20 described above may be a smartphone, a tablet terminal, a notebook computer or the like that has an appropriate communication function that allows communication with the network 1. The user terminal 20 may also have a communication function for short-range wireless communication in addition to the communication function intended for the network 1 described above, in order to perform data communication with the electrical kitchen appliance 30 (such as data communication for setting a recipe detail). An example of software retained by the user terminal 20 is a mobile application or app 29 running on a mobile terminal.

The app 29 allows browsing of a recipe via a browsing function on the recipe website published by the recipe suggestion apparatus 10 and also has a function that allows posting of a recipe to the recipe website as required.

A person who operates the user terminal 20 accesses the recipe website using the user terminal 20. Then, the person has an intention to browse a desired recipe, set the recipe in the person's electrical kitchen appliance 30, and effectively use the recipe for cooking. Note that a person who has such an intention and actually use a recipe is referred to as a recipe user.

In the following, a specific configuration of the recipe suggestion apparatus 10 according to this embodiment and procedures performed by the apparatus will be described step by step.

<Configuration of Recipe Suggestion Apparatus>

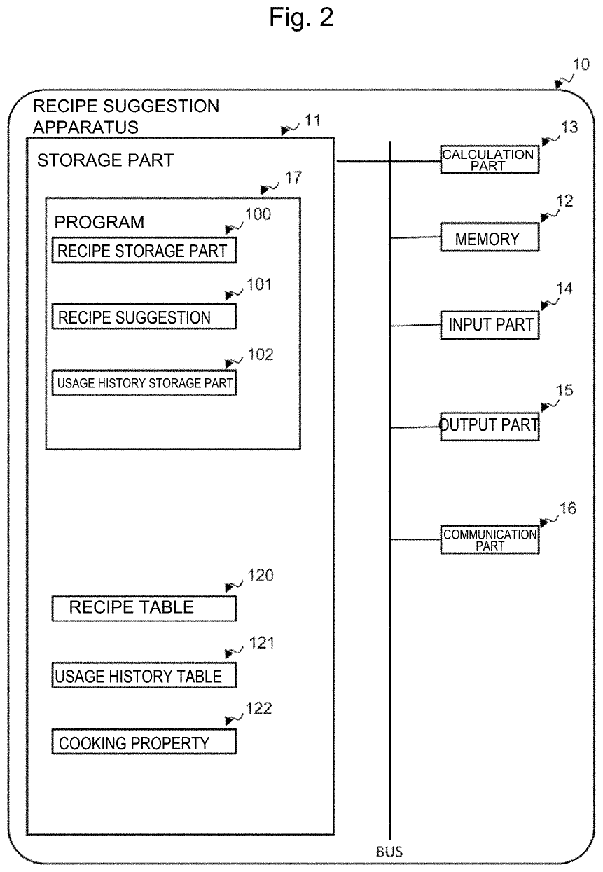

As shown in FIG. 2, the recipe suggestion apparatus 10 according to this embodiment includes a storage part 11, a memory 12, a calculation part 13, an input part 14, an output part 15 and a communication part 16.

Of these parts, the storage part 11 is formed by a nonvolatile storage element, such as a hard disk drive (HDD) or a solid state drive (SSD).

The storage part 11 at least stores a program 17 for implementing a required function of the recipe suggestion apparatus according to this embodiment, a recipe table 120, a usage history table 121, and a cooking property table 122. These tables will be described in detail later. The memory 12 is formed by a volatile storage element, such as a RAM.

The calculation part 13 may be a CPU that loads the program 17 stored in the storage part 11 into the memory 12 and executes the program 17 to implement a required function of the recipe suggestion apparatus.

Functions implemented include the function of a recipe storage part 100, the function of a recipe suggestion part 101 and the function of a usage history storage part 102. These parts will be described in detail later.

The input part 14 may be a keyboard, a mouse, a keypad, a touch panel, a microphone or the like that receives a key input or audio input from the user. The output part 15 may be a display that displays processed data, for example.

The communication part 16 may be a network interface card (NIC) or the like that connects to the network 1 and communicates with another apparatus, such as the user terminal 20 or the electrical kitchen appliance 30.

Note that the input part 14 and the output part 15 described above are not essential components. These components are needed when the recipe suggestion apparatus 10 is configured so that the input part 14 receives a request for recipe posting or recipe search from the user and the output part 15 displays the processing result.

<Configuration of User Terminal>

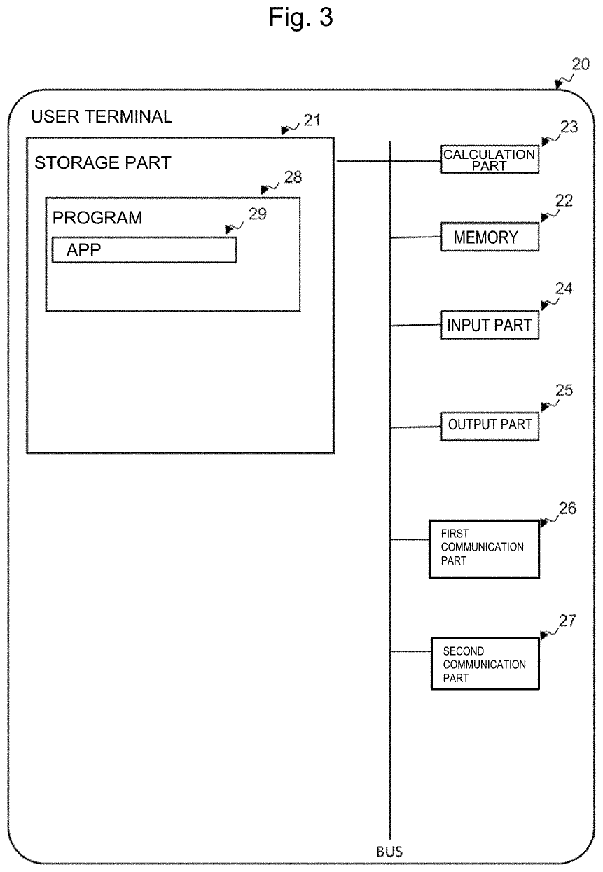

Next, a configuration example of the user terminal 20 according to this embodiment will be described. FIG. 3 is a diagram showing a configuration example of the user terminal 20 according to this embodiment. As shown in FIG. 3, the user terminal 20 according to this embodiment includes a storage part 21, a memory 22, a calculation part 23, an input part 24, an output part 25, a first communication part 26 and a second communication part 27.

Of these parts, the storage part 21 is formed by a nonvolatile storage element, such as a hard disk drive (HDD) or a solid state drive (SSD).

The storage part 21 at least stores the app 29 as a program 28 for implementing a required function of the user terminal according to this embodiment. As described above, the app 29 allows browsing of a recipe via a browsing function on the recipe website published by the recipe suggestion apparatus 10. The memory 22 is formed by a volatile storage element, such as a RAM. The calculation part 23 may be a CPU that loads the program 28 stored in the storage part 21 into the memory 22 and executes the program 28 to implement a required function of the user terminal.

The input part 24 may be a keyboard, a mouse, a keypad, a touch panel, a microphone or the like that receives a key input or audio input from the user. The output part 25 may be a display that displays processed data, for example.

The first communication part 26 may be a network interface card (NIC) or the like that connects to the network 1 and communicates with another apparatus, such as the recipe suggestion apparatus 10.

The second communication part 27 may be a unit that performs short-range wireless communication, such as wireless communication or infrared communication, at a particular frequency (such as in a 2.4 GHz band) with the electrical kitchen appliance 30.

<Configuration of Electrical Kitchen Appliance>

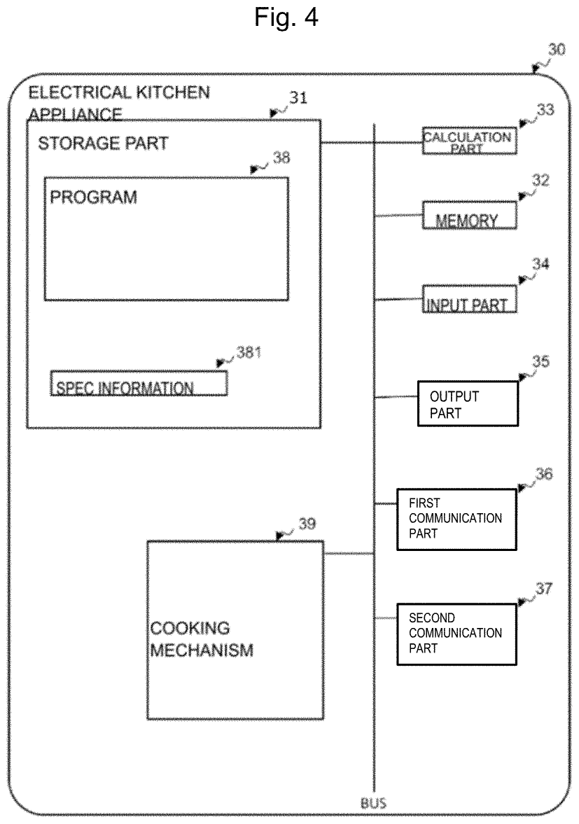

Next, a configuration example of the electrical kitchen appliance 30 according to this embodiment will be described. FIG. 4 is a diagram showing a configuration example of the electrical kitchen appliance 30 according to this embodiment. The electrical kitchen appliance 30 is a cooking appliance used for cooking by the user of the user terminal 20. A typical specific example of the electrical kitchen appliance 30 may be a microwave oven or a water oven. In any case, the electrical kitchen appliance 30 is an apparatus that automatically performs a cooking operation according to a recipe once a predetermined data setup is made according to the recipe.

The electrical kitchen appliance 30 includes a storage part 31, a memory 32, a calculation part 33, an input part 34, an output part 35, a first communication part 36, a second communication part 37, a program 38 and a cooking mechanism 39.

Of these parts, the storage part 31 is formed by a nonvolatile storage element, such as a hard disk drive (HDD) or a solid state drive (SSD).

The storage part 31 at least stores the program 38 for implementing a required function of the electrical kitchen appliance 30 according to this embodiment. The program 38 controls the cooking mechanism 39 according to a data setup according to a recipe.

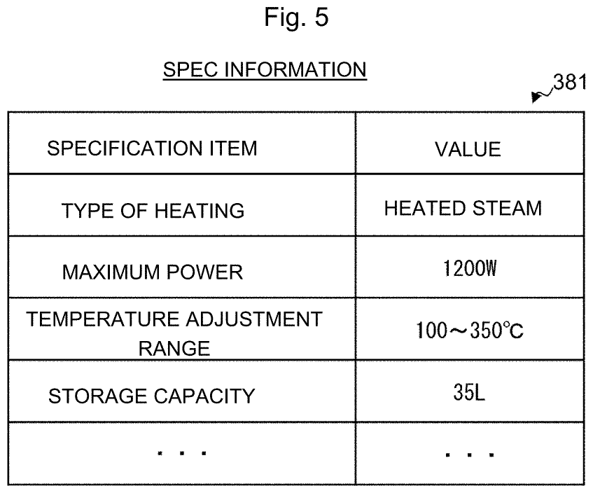

The electrical kitchen appliance 30 retains spec information 381 (see FIG. 5) on the electrical kitchen appliance 30. The spec information 381 is specification information on the electrical kitchen appliance 30, which indicates values concerning items, such as the type of heating, the maximum power, the temperature adjustment range and the storage capacity. The memory 32 is formed by a volatile storage element, such as a RAM. The calculation part 33 may be a CPU that loads the program 38 stored in the storage part 31 into the memory 32 and executes the program 38 to implement a required function of the electrical kitchen appliance.

The input part 34 may be a touch panel, a button, a microphone or the like that receives a key input or audio input from the user. The output part 35 may be a display that displays processed data, for example.

The first communication part 36 may be a network interface card (NIC) or the like that connects to the network 1 and communicates with another apparatus, such as the recipe suggestion apparatus 10.

The second communication part 37 may be a unit that performs short-range wireless communication, such as wireless communication or infrared communication, at a particular frequency (such as in a 2.4 GHz band) with the user terminal 20.

The cooking mechanism 39 is a common mechanism provided in the microwave oven, the water oven or the like described above. For example, the cooking mechanism 39 is an assembly of units for various cooking operations, such as heating of an ingredient to be cooked or a cooking space, addition of water, rotation, air exhaustion, or sensing.

The cooking mechanism 39 is controlled by the program 38. For example, the cooking mechanism 39 performs various cooking operations, such as heating, addition of water, rotation or air exhaustion to a predetermined reference value, based on the temperature, the humidity or the like of an ingredient or the cooking space detected by a sensing unit.

<Specific Examples of Data>

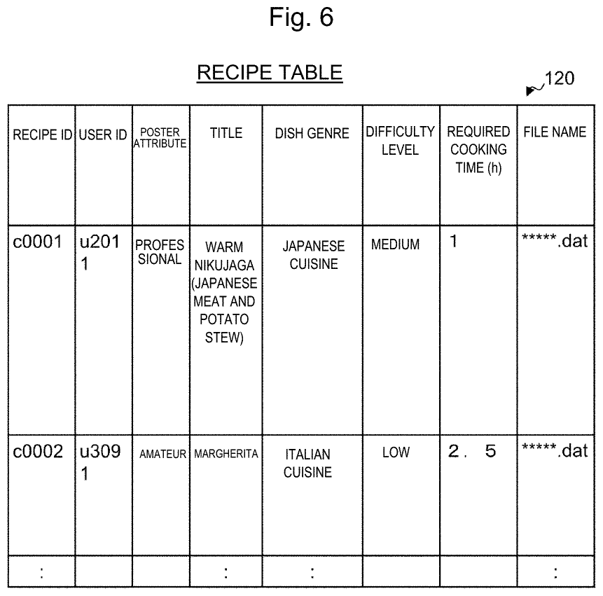

Next, various databases used by the recipe suggestion apparatus 10 according to this embodiment will be described. FIG. 6 shows an example of the recipe table 120 according to this embodiment.

The recipe table 120 is a table that stores a recipe posted from the user terminal 20, for example. A structure of the recipe table 120 is a group of records of data, such as the user ID of the poster of a recipe, an attribute (such as professional or amateur) of the poster, the title of the recipe, the genre of cooking, the difficulty level, the required cooking time, and the file name (which may be a storage location address), which are associated by a recipe ID, as a key item, that uniquely identifies the recipe, for example.

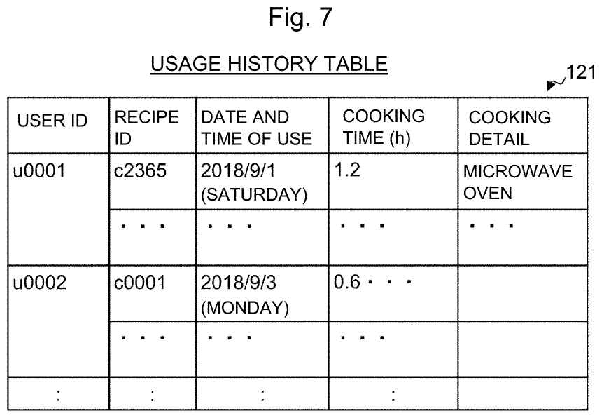

FIG. 7 shows an example of the usage history table 121 according to this embodiment. The usage history table 121 is a table that stores a usage history of a recipe stored in the recipe table 120 described above.

A structure of the usage history table 121 is a group of records of data, such as a recipe ID of a recipe used by a recipe user, a date and time of usage, an actual cooking time taken when a recipe user used a recipe, and a cooking detail, which are associated by a user ID, as a key item, that uniquely identifies a recipe user, for example. Note that the cooking detail described above may be the type of the electrical kitchen appliance 30 used by the recipe user, for example.

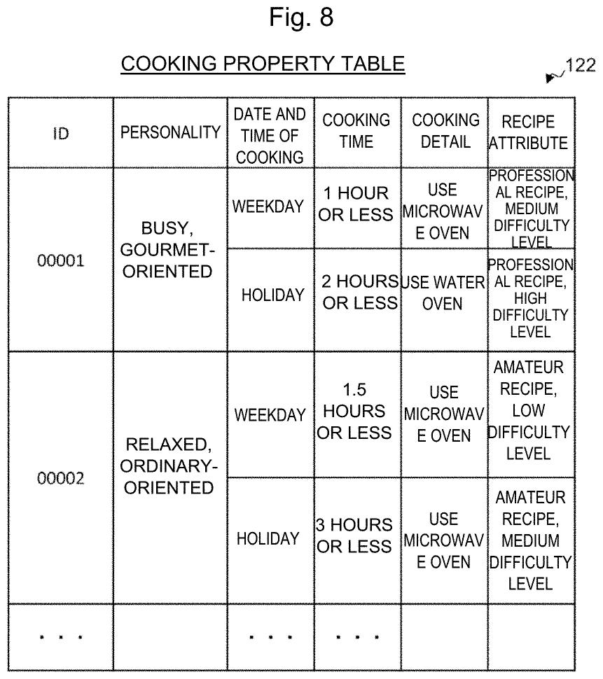

FIG. 8 is a diagram showing a configuration example of the cooking property table 122 according to this embodiment. The cooking property table 122 is a table that stores a lifestyle of a recipe user and a property personally required by the recipe user of the lifestyle for cooking according to the recipe, which are determined based on at least any of an actual cooking time of the recipe user, a cooking detail, and a predetermined attribute of the recipe used by the recipe user.

A structure of the cooking property table 122 is a group of records of a lifestyle of a recipe user and cooking properties required by the recipe user including a date and time of cooking, a cooking time, a cooking detail and a recipe attribute, which are associated by an ID, as a key, that uniquely identifies a record, for example.

As a specific example of the records, provided that the recipe user is a person whose lifestyle is “busy and gourmet-oriented”, and the date and time of cooking is “weekday”, a combination of “1 hour or less” as a cooking time, “use microwave oven” as a cooking detail, and “professional recipe of medium difficulty level” as a recipe attribute may be defined as cooking properties required by the recipe user of that lifestyle.

As another example for the recipe user of the same lifestyle as described above, provided that the date and time of cooking is “holiday”, a combination of “2 hours or less” as a cooking time, “use water oven” as a cooking detail, and “professional recipe of high difficulty level” as a recipe attribute may be defined as cooking properties required by the recipe user of that lifestyle.

<Function of Recipe Storage Part>

As described above, the recipe suggestion apparatus 10 has the functions of the recipe storage part 100, the recipe suggestion part 101 and the usage history storage part 102. Of these parts, the recipe storage part 100 receives a recipe posted from the user terminal 20 and stores the recipe in the recipe table 120 in the storage part 11.

In the storing, the recipe storage part 100 assigns a recipe ID according to a predetermined rule or algorithm, and generates a record of data, such as the user ID of the poster of the recipe, an attribute (such as professional or amateur) of the poster, the title of the recipe, descriptions, the genre of cooking, the difficulty level, the required cooking time, and the file name (which may be a storage location address), which are associated by the recipe ID as a key.

Values of all of the user ID, the attribute (such as professional or amateur) of the poster, the title of the recipe, the descriptions, the genre of cooking, the difficulty level, the required cooking time, and the file name (which may be a storage location address) are included in the data of the recipe posted from the user terminal 20.

<Function of Recipe Suggestion Part>

The recipe suggestion part 101 receives a predetermined recipe suggestion request from the user terminal 20, and obtains the spec information 381 on the electrical kitchen appliance 30 of the recipe user by requesting the spec information 381 from the user terminal 20 or the electrical kitchen appliance 30. The spec information 381 obtained here is specification information on the electrical kitchen appliance 30, which indicates values concerning items, such as the type of heating, the maximum power, the temperature adjustment range and the storage capacity.

From among the recipes stored in the recipe table 120, the recipe suggestion part 101 identifies a recipe the value of a cooking operation corresponding to a quantitative description in which falls within a predetermined range from a performance upper limit in the spec information 381 obtained as described above.

For example, when the spec information 381 obtained for the “microwave oven” of the recipe user indicates that the “maximum power”, which is a performance upper limit, is “1200 W”, a recipe in which a set output value, which is a quantitative description, concerning the cooking operation “heating” of the “microwave oven” is smaller than the “1200 W” described above by “10%” or less, that is, falls within a range “from 1080 W to 1200 W” is identified from among the recipes stored in the recipe table 120. The recipe suggestion part 101 delivers the identified recipe to the user terminal 20 that has transmitted the recipe suggestion request described above to the recipe suggestion part 101.

Note that, of course, the recipe identified and delivered as described above meets the other requirements of the recipe user, such as the name of the dish such as “nikujaga (Japanese meat and potato stew)”, the genre of the dish such as “Japanese cuisine”, and the amount such as “two servings”.

Alternatively, as described later, the recipe suggestion part 101 may identify a population of recipes having an attribute fitting to the recipe user based on the usage history table 121 and the cooking property table 122, and identify a recipe that falls within a predetermined range from the performance upper limit described above from the population.

In the latter case, the recipe suggestion part 101 determines a property personally required by the recipe user for cooking according to the recipe based on at least any of the actual cooking time of the recipe user, the cooking detail, and the predetermined attribute of the recipe used by the recipe user indicated in each usage history in the usage history table 121, and stores the property in the cooking property table 122.

More specifically, the recipe suggestion part 101 searches the usage history table 121 for records using the user ID of the recipe user as a key, and obtains values concerning the recipe ID of a used recipe, the date and time of usage of the same, the actual cooking time taken when the recipe user used the recipe, and the cooking detail (such as the type of the electrical kitchen appliance 30 used) indicated by each record found.

The recipe suggestion part 101 performs a statistical processing on the values of each record obtained as described above to identify a cooking property specific to the recipe user, and stores the cooking property in the cooking property table 122. In the statistical processing in this case, for example, an average value of the “cooking times” of all the relevant records and an average value of the cooking times for the other recipe users are calculated. The two average values are compared, and if the average value of the cooking times for the recipe user is smaller, or in other words, if the cooking times for the recipe user tend to be shorter, the lifestyle of the recipe user is determined to be “busy”.

Furthermore, concerning the “date and time of cooking”, the frequency of occurrence of “weekday” and the frequency of occurrence of “holiday” are calculated and compared, and the attribute the frequency of occurrence of which is higher is determined to be one of the cooking properties required by the recipe user.

Furthermore, concerning the “cooking detail”, the frequency of occurrence of “use microwave oven” and the frequency of occurrence of “use water oven” are calculated and compared, and the attribute the frequency of occurrence of which is higher is determined to be one of the cooking properties required by the recipe user.

Furthermore, concerning the recipe attribute as a cooking property required by the recipe user, the frequency of occurrence of “professional recipe” and the frequency of occurrence of “amateur recipe” are calculated and compared, and the attribute the frequency of occurrence of which is higher is determined to be one aspect of the lifestyle of the recipe user (for example, a person who tends to use a professional recipe is gourmet-oriented, and a person who tends to use an amateur recipe is ordinary-oriented) and one of the cooking properties required by the recipe user (such as whether the recipe user tends to want to use a professional recipe or an amateur recipe). Such a determination is performed for the “difficulty level” in the same manner as for the recipe attribute.

In this way, concerning the “lifestyle” of the recipe user, the recipe suggestion part 101 generates a combination condition for items such as “date and time of cooking”, “cooking time”, “cooking detail” and “recipe attribute”, and stores the combination condition in the cooking property table 122 as one record. The record stored in the cooking property table 122 is shared by another recipe user whose “lifestyle” agrees with that of this recipe user.

Thus, the recipe suggestion part 101 refers to the cooking property table 122 described above for a cooking property for a recipe user the value of “lifestyle” of whom is the same as that of the recipe user who has transmitted the recipe suggestion request, identifies recipes containing the cooking property as an attribute in the recipe table 120, designates the group of the identified recipes as a population, identifies in the population a recipe that falls within a predetermined range from a performance upper limit described above, and delivers the identified recipe to the user terminal 20 of the recipe user.

Specifically, for the recipe user who has transmitted the recipe suggestion request, if cooking properties, such as “busy and gourmet-oriented” as the lifestyle, “weekday” as the date and time of cooking, “1 hour or less” as the cooking time, “use microwave oven” as the cooking detail, and “professional recipe of medium difficulty level” as the recipe attribute, are identified from the usage history for the recipe user as described above, the recipe suggestion part 101 identifies a recipe that meets the conditions of these items in the recipe table 120, designates the group of the identified recipes as a population, identifies from among the recipes included in the population a recipe the value of a cooking operation corresponding to a quantitative description in which falls within a predetermined range from a performance upper limit in the spec information 381, and delivers the identified recipe to the user terminal 20.

<Function of Usage History Storage Part>

The usage history storage part 102 obtains various information concerning a recipe user who has browsed and used a recipe on the recipe website and details of the usage from the user terminal 20 or various logs concerning the recipe browsing on the recipe website from the user terminal 20, for example, and stores the information in the usage history table 121.

The information to be stored is data, such as the recipe ID of the recipe used by the recipe user, the date and time of the usage, the actual cooking time taken when the recipe user used the recipe, and the cooking detail, which are associated by the user ID, as a key item, that uniquely indicates the recipe user, as shown in FIG. 7.

<Recipe Suggestion Method>

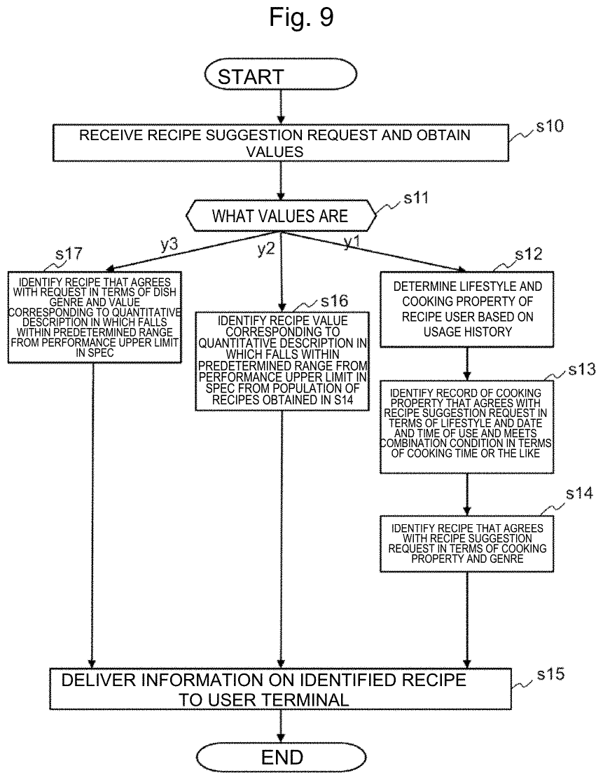

Next, an actual procedure of a recipe suggestion method according to this embodiment will be described with reference to the drawings. Various operations in the recipe suggestion method described below are implemented by a program executed by the recipe suggestion apparatus 10, for example. The program is formed by codes for implementing the various operations described below. FIG. 9 is a diagram showing a flow example 1 of the recipe suggestion method according to this embodiment. Here, a flow of a process mainly performed by the recipe suggestion part 101 will be described.

In this case, it is assumed that a user (recipe user) of the recipe website wants to receive a suggestion of a preferable recipe and uses the user terminal 20 to transmit a recipe suggestion request to notify the recipe suggestion apparatus 10 of that.

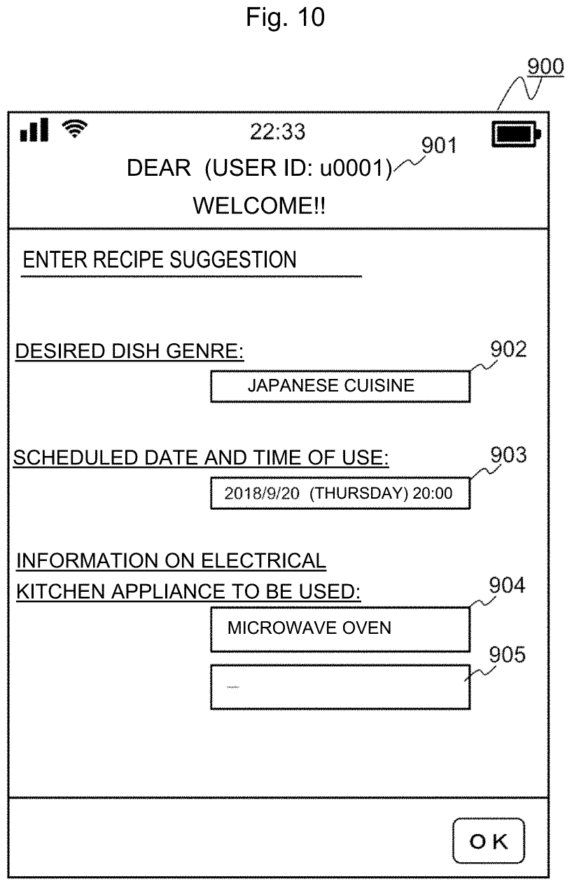

The recipe suggestion apparatus 10 delivers a screen (screen 900 in FIG. 10) for accepting a request for recipe suggestion to the user terminal 20. As illustrated in the screen 900 in FIG. 10, of values of a user ID 901 of the recipe user, a desired dish genre 902, a scheduled date and time of use 903 of the recipe, a type 904 of the electrical kitchen appliance 30 to be used, spec information 905, a recipe suggestion request may include at least the user ID, the desired dish genre, and the scheduled date and time of use.

Note that the spec information 905 on the electrical kitchen appliance 30 to be used described above is specification information on the electrical kitchen appliance 30, which indicates values concerning items, such as the type of heating, the maximum power, the temperature adjustment range and the storage capacity.

The recipe suggestion part 101 of the recipe suggestion apparatus 10 receives a recipe suggestion request from the user terminal 20 on the screen 900 described above, and obtains values included in the recipe suggestion request (s10).

When the values obtained in s10 are only the user ID, the desired dish genre (such as Japanese cuisine) and the scheduled date and time of use (such as Thursday Sep. 20, 2018) (if y1 in s11), the recipe suggestion part 101 determines a lifestyle of the recipe user and a property personally required for cooking according to the recipe based on at least any of the actual cooking time of the recipe user, the cooking detail and the predetermined recipe attribute used by the recipe user indicated in each usage history in the usage history table 121 (s12).

In s12, the recipe suggestion part 101 searches the usage history table 121 for records using the user ID obtained in s10 as a key. The recipe suggestion part 101 then obtains values concerning the recipe ID of the used recipe, the date and time of usage of the same, the actual cooking time taken when the recipe user used the recipe, and the cooking detail (such as the type of the electrical kitchen appliance 30 used, or any temperature, time or the like modified in the recipe) indicated by each record found. The recipe suggestion part 101 performs a statistical processing on the values of each record obtained as described above to identify a lifestyle and a cooking property specific to the recipe user.

In the statistical processing in this case, for example, an average value of the “cooking times” of all the relevant records and an average value of the cooking times for the other recipe users are calculated. The two average values are compared, and if the average value of the cooking times for the recipe user is smaller, or in other words, if the cooking times for the recipe user tend to be shorter, the lifestyle of the recipe user is determined to be “busy”.

Furthermore, concerning the recipe attribute as a cooking property required by the recipe user, the frequency of occurrence of “professional recipe” and the frequency of occurrence of “amateur recipe” are calculated and compared, and the attribute the frequency of occurrence of which is higher is determined to be one aspect of the lifestyle of the recipe user and one of the cooking properties required by the recipe user. Such a determination is performed for the “difficulty level” in the same manner as for the recipe attribute.

Furthermore, concerning the “cooking detail”, the frequency of occurrence of “use microwave oven” and the frequency of occurrence of “use water oven” are calculated and compared, and the attribute the frequency of occurrence of which is higher is determined to be one of the cooking properties required by the recipe user.

In this way, the recipe suggestion part 101 generates a combination condition for items such as “lifestyle”, “date and time of cooking”, “cooking time”, “cooking detail” and “recipe attribute” for the recipe user.

The recipe suggestion part 101 then refers to the cooking property table 122 for a record of a cooking property that meets the combination condition in terms of “length of cooking time”, “cooking detail” and “recipe attribute” in the case of the property of the recipe user determined in s12, that is, the “lifestyle” of the recipe user who has transmitted the recipe suggestion request, and the “date and time of cooking (weekday or holiday)” obtained from the recipe suggestion request in s10 (s13).

For example, of records concerning recipe users of a lifestyle of “busy and gourmet-oriented”, records of cooking properties such as “weekday” as the date and time of cooking, “1 hour or less” as the cooking time, “use microwave oven” and “professional recipe of medium difficulty level” are referred to.

Furthermore, the recipe suggestion part 101 identifies, in the recipe table 120, a recipe that relates to the dish genre obtained from the recipe suggestion request in s10 and includes, as attributes, the cooking properties identified concerning a situation where the recipe user having a “busy and gourmet-oriented” lifestyle cooks on a weekday (s14).

In the specific example described above, a recipe that relates to the dish genre (such as Japanese cuisine) obtained from the recipe suggestion request in s10 and includes “1 hour or less” as the cooking time and “use microwave oven” and “professional recipe of medium difficulty level” as cooking properties is identified in the recipe table 120.

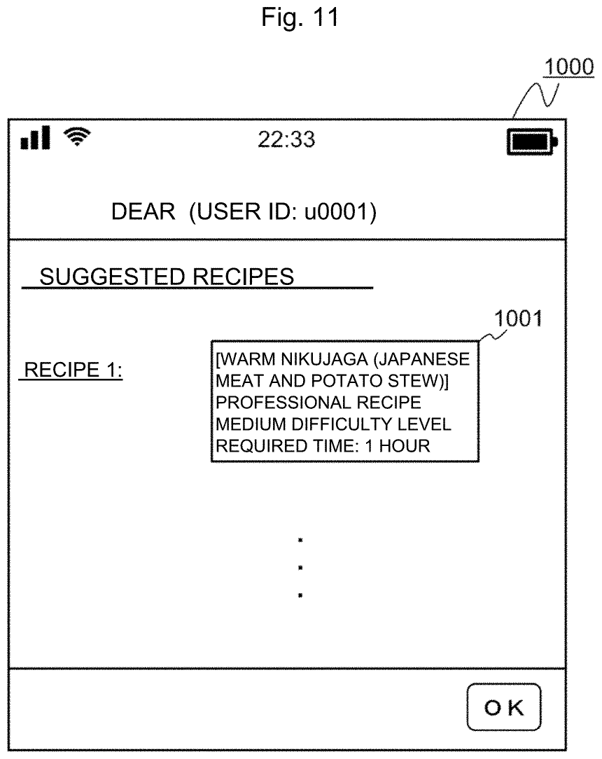

The recipe suggestion part 101 then delivers information 1001 on the recipe identified in s14 to the user terminal 20 (see a screen 1000 in FIG. 11) (s15), and ends the process. The information 1001 on the recipe is transmitted from the user terminal 20 to the electrical kitchen appliance 30, set in the electrical kitchen appliance 30, and used for automatic control of the electrical kitchen appliance 30, as far as the information 1001 is data in the machine readable recipe (MRR) format.

If, in the determination in s11 described above, the values obtained in s10 includes not only the user ID, the desired dish genre (such as Japanese cuisine) and the scheduled date and time of use (such as next Monday) but also the information on the electrical kitchen appliance 30 to be used, that is, the spec information 381 (if y2 in s11), the recipe suggestion part 101 designates the recipes identified in s14 as a population, and identifies, from among the recipes included in the population, a recipe the value of a cooking operation corresponding to a quantitative description in which falls within a predetermined range from a performance upper limit in the spec information 381 described above (s16).

For example, when the spec information 381 obtained in s10 relates to “microwave oven” and indicates that the “maximum power”, which is a performance upper limit, is “1200 W”, a recipe in which a set output value, which is a quantitative description, concerning the cooking operation “heating” of the “microwave oven” is smaller than the “1200 W” described above by “10%” or less, that is, falls within a range “from 1080 W to 1200 W” is identified from among the recipes included in the population.

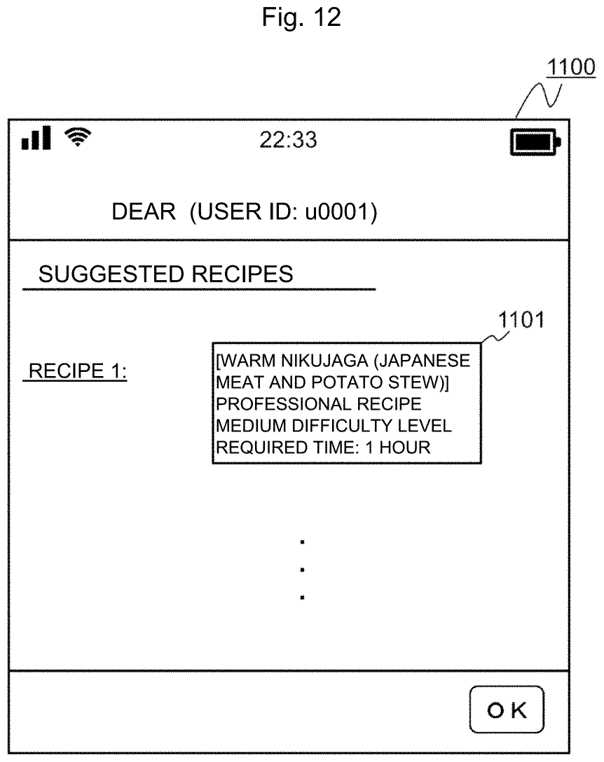

The recipe suggestion part 101 then delivers information 1101 on the recipe identified in s16 to the user terminal 20 (see a screen 1100 in FIG. 12) (s15), and ends the process. The information 1101 on the recipe is transmitted from the user terminal 20 to the electrical kitchen appliance 30, set in the electrical kitchen appliance 30, and used for automatic control of the electrical kitchen appliance 30, as far as the information 1101 is data in the machine readable recipe (MRR) format.

If, in the determination in s11 described above, the values obtained in s10 are only the user ID, the desired dish genre (such as Japanese cuisine) and the information on the electrical kitchen appliance 30 to be used, that is, the spec information 381 (if y3 in s11), the recipe suggestion part 101 identifies, from among the recipes stored in the recipe table 120, a recipe whose dish genre is the user's desired one and the value of a cooking operation corresponding to a quantitative description in which falls within a predetermined range from a performance upper limit in the spec information 381 (s17).

For example, when the desired dish genre is “Japanese cuisine”, and the spec information 381 obtained concerning the “microwave oven” of the recipe user indicates that the “maximum power”, which is a performance upper limit, is “1200 W”, a recipe in which a set output value, which is a quantitative description, concerning the cooking operation “heating” of the “microwave oven” is smaller than the “1200 W” described above by “10%” or less, that is, falls within a range “from 1080 W to 1200 W” is identified from among the recipes of “Japanese cuisine” stored in the recipe table 120.

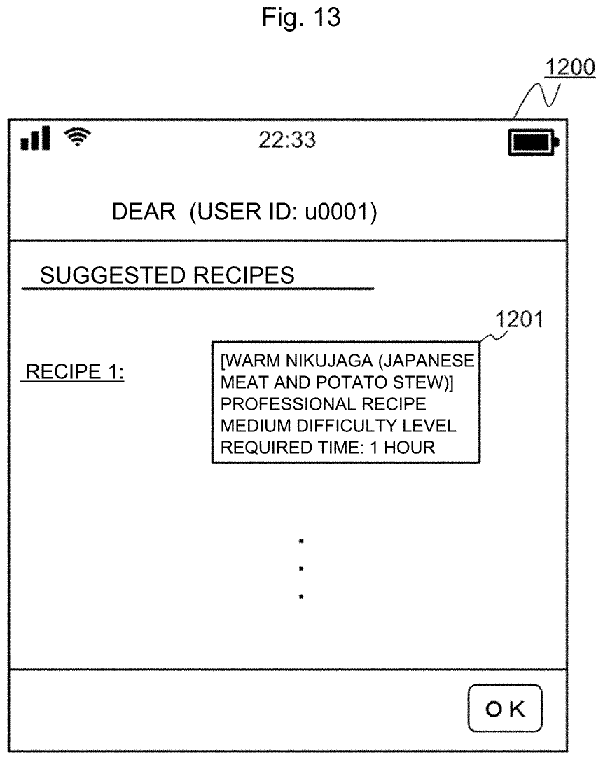

The recipe suggestion part 101 then delivers information 1201 on the identified recipe to the user terminal 20 that has transmitted the recipe suggestion request described above (see a screen 1200 in FIG. 13) (s15), and ends the process. The information 1201 on the recipe is transmitted from the user terminal 20 to the electrical kitchen appliance 30, set in the electrical kitchen appliance 30, and used for automatic control of the electrical kitchen appliance 30, as far as the information 1201 is data in the machine readable recipe (MRR) format.

Although the best mode for carrying out the present disclosure or the like have been specifically described above, the present disclosure is not limited to those modes, and various modifications are possible without departing from the spirit of the present disclosure.

According to this embodiment described above, an appropriate recipe that meets the specs of an electrical kitchen appliance or the personal taste of a user can be suggested.

Note that the recipe suggestion method according to this embodiment may be implemented by recording a program for implementing various functions of the recipe suggestion apparatus in a computer-readable recording medium, loading the program recorded in the recording medium into a computer system, and instructing the computer system to implement the recipe suggestion method.

Specifically, the program described above is a program that makes a computer function as an information processing apparatus that stores recipes and performs a step of obtaining spec information on a cooking appliance of a predetermined user from a terminal of the user or the cooking appliance, a step of identifying, in the recipes, a recipe a value of a cooking operation corresponding to a quantitative description in which falls within a predetermined range from a performance upper limit in the spec information, and a step of delivering the identified recipe to the terminal of the user.

The program described above is also a program that makes a computer function as the information processing apparatus that further stores a recipe usage history of the user, and the information processing apparatus performs a step of determining a property personally required by the user for cooking according to the recipe based on at least any of an actual cooking time of the user, a cooking detail, and a predetermined attribute of a recipe used by the user indicated by the usage history, a step of identifying a recipe that includes the property as an attribute, and a step of delivering the identified recipe to the terminal of the user.

The “computer system” herein includes an OS and hardware, such as peripheral devices. The “computer-readable recording medium” refers to a transportable medium, such as a flexible disk, a magneto-optical disk, a ROM, a CD-ROM or an USB memory, or a storage device, such as a hard disk or SSD, incorporated in the computer system.

The “computer-readable recording medium” may further include a medium that dynamically retain a program for a short time, such as a communication line in the case where a program is transmitted over a network such as the Internet or a communication line such as a telephone line, or a medium that retains a program for a certain time, such as a volatile memory in a computer system serving as a server or a client in such a case.

The program may be a program intended for implementing some of the functions described above or may be a program that can implement the functions described above in cooperation with another program recorded in a computer system in advance.

### REFERENCE SIGNS LIST

1 network
10 recipe suggestion apparatus
11 storage part
12 memory
13 calculation part
14 input part
15 output part
16 communication part
17 program
100 recipe storage part
101 recipe suggestion part
102 usage history storage part
120 recipe table
121 usage history table
122 cooking property table
20 user terminal
21 storage part
22 memory
23 calculation part
24 input part
25 output part
26 first communication part
27 second communication part
28 program
29 app
30 electrical kitchen appliance
31 storage part
32 memory
33 calculation part
34 input part
35 output part
36 first communication part
37 second communication part
38 program
381 spec information
39 cooking mechanism

1. A recipe suggestion apparatus, comprising:
a memory that stores a plurality of recipes; and
circuitry configured to
obtain, via the internet, spec information on a cooking appliance of a predetermined user from a user terminal of the predetermined user or the cooking appliance, the spec information indicating a performance upper limit of the cooking appliance,
identify, from the plurality of recipes, at least one target recipe in which a value of a cooking operation corresponding to a quantitative description falls within a predetermined range of the performance upper limit indicated by the spec information, and
send, via the internet, the identified target recipe to the user terminal.

2. The recipe suggestion apparatus according to claim 1, wherein the circuitry is further configured to:
manage a usage history of at least one of the plurality of recipes for the user,
determine a cooking property which is personally required by the user for cooking according to the usage history of the at least one of the plurality of recipes, the usage history of the at least one of the plurality of recipes including at least any of an actual cooking time of the user, a cooking tool, and a predetermined attribute of the recipe used by the user,
identify the target recipe that matches the cooking property as an attribute of the recipe, and
send, via the internet, the identified target recipe to the user terminal.

3. The recipe suggestion apparatus according to claim 1, wherein the cooking appliance performs autonomous cooking by inputting data corresponding to the identified target recipe.

4. The recipe suggestion apparatus according to claim 1, wherein a format of at least one of the plurality of recipes is Machine Readable Recipe (MRR) format.

5. The recipe suggestion apparatus according to claim 2, wherein the circuitry is further configured to receive, via the internet, a recipe suggestion request from the user, the recipe suggestion request including at least one of a user identification (ID), a request genre, a planned date for cooking the target recipe, and the spec information on the cooking appliance.

6. The recipe suggestion apparatus according to claim 5, wherein the circuitry is further configured to manage a plurality of candidates of the coking property based on information of a lifestyle of the user, in advance to the determination of the cooking property.

7. The recipe suggestion apparatus according to claim 1, wherein the circuitry is configured to:
obtain, via the internet, the spec information from the cooking appliance, the cooking appliance being connected with the recipe suggestion apparatus via the internet,
send, via the internet, the identified target recipe to the cooking appliance, and
control, via the internet, the cooking appliance to perform autonomous cooking based on the identified target recipe.

8. A recipe suggestion method, comprising:
obtaining, via the internet, spec information on a cooking appliance of a predetermined user from a user terminal of the predetermined user or the cooking appliance, the spec information indicating a performance upper limit of the cooking appliance,
identifying, using circuitry, from a plurality of recipes, at least one target recipe in which a value of a cooking operation corresponding to a quantitative description falls within a predetermined range of the performance upper limit indicated by the spec information, and
sending, via the internet, the identified target recipe to the user terminal.

9. The recipe suggestion method according to claim 8, further comprising:
managing a usage history of at least one of the plurality of recipes for the user, and
determining a cooking property which is personally required by the user for cooking according to the usage history of the at least one of the plurality of recipes, the usage history of the at least one of the plurality of recipes including at least any of an actual cooking time of the user, a cooking tool, and a predetermined attribute of the recipe used by the user indicated by the usage history,
identifying the target recipe that matches the cooking property as an attribute of the recipe, and
sending, via the internet, the identified target recipe to the user terminal.

10. The recipe suggestion method according to claim 8, wherein the cooking appliance performs autonomous cooking by inputting data corresponding to the identified target recipe.

11. The recipe suggestion method according to claim 8, wherein a format of at least one of the plurality of recipes is Machine Readable Recipe (MRR) format.

12. The recipe suggestion method according to claim 9, wherein further comprising:
receiving, via the internet, a recipe suggestion request from the user, the recipe suggestion request including at least one of a user identification (ID), a request genre, a planned date for cooking the target recipe, and the spec information on the cooking appliance.

13. The recipe suggestion method according to claim 12, wherein further comprising:
managing a plurality of candidates of the coking property based on information of a lifestyle of the user, in advance to the determination of the cooking property.

14. The recipe suggestion method according to claim 8, further comprising:
obtaining, via the internet, the spec information from the cooking appliance, the cooking appliance being connected with the recipe suggestion apparatus via the internet,
sending, via the internet, the identified target recipe to the cooking appliance, and
controlling, via the internet, the cooking appliance to perform autonomous cooking based on the identified target recipe.

15. A non-transitory computer-readable recording medium that stores a program which causes a computer to execute a method for controlling a recipe suggestion apparatus, the method comprising:
obtaining, via the internet, spec information on a cooking appliance of a predetermined user from a user terminal of the predetermined user or the cooking appliance, the spec information indicating a performance upper limit of the cooking appliance,
identifying, in a plurality of recipes, at least one target recipe in which a value of a cooking operation corresponding to a quantitative description falls within a predetermined range of the performance upper limit identified by the spec information, and
sending, via the internet, the identified target recipe to the user terminal.

16. The non-transitory computer-readable recording medium according to claim 15, the method further comprising:
managing a usage history of at least one of the plurality of recipes for the user,
determining a cooking property which is personally required by the user for cooking according to the usage history of the at least one of the plurality of recipes, the usage history of the at least one of the plurality of recipes including at least any of an actual cooking time of the user, a cooking tool, and a predetermined attribute of the recipe used by the user indicated by the usage history,
identifying the target recipe that matches the cooking property as an attribute of the recipe a recipe that includes the property as an attribute, and
sending, via the internet, the identified target recipe to the user terminal.

17. The non-transitory computer-readable recording medium according to claim 15, wherein the cooking appliance performs autonomous cooking by inputting data corresponding to the identified target recipe.

18. The non-transitory computer-readable recording medium according to claim 15, wherein a format of at least one of the plurality of recipes is Machine Readable Recipe (MRR) format.

19. The non-transitory computer-readable recording medium according to claim 16, wherein the method further comprising:
receiving, via the internet, a recipe suggestion request from the user, the recipe suggestion request including at least one of a user identification (ID), a request genre, a planned date for cooking the target recipe, and the spec information on the cooking appliance.

20. The non-transitory computer-readable recording medium according to claim 19, wherein the method further comprising:
managing a plurality of candidates of the coking property based on information of a lifestyle of the user, in advance to the determination of the cooking property.
